(19) United States
(12) Patent Application Publication
(10) Pub. No.: US 2011/0013273 A1
(43) Pub. Date: Jan. 20, 2011

(54) Spectral Selective Solar Control Film Containing an Air Layer for Windows

(76) Inventors: Stephen S. Wilson, Las Vegas, NV (US); Bart Wilson, Las Vegas, NV (US); Seth Wilson, Las Vegas, NV (US)

Correspondence Address: STETINA BRUNDA GARRED & BRUCKER, 75 ENTERPRISE, SUITE 250, ALISO VIEJO, CA, 92656, US

(21) Appl. No.: 12/762,486

(22) Filed: Apr. 19, 2010

Related U.S. Application Data
(63) Continuation-in-part of application No. 12/503,686, filed on Jul. 15, 2009.

(51) Int. Cl. G02B 5/26; B32B 37/12

(52) U.S. Cl. 359/360; 156/71

(57) ABSTRACT

A building structure having a high efficiency solar control system is provided. The building structure may have a window defined by a sheet of glass and a film mounted to its exterior side. There may be a gap between the film and the glass wherein the film, film and gap, or gap provides thermal insulation. The film may reflect solar radiation in the near and mid infrared ranges yet allow high transmission of light in the visible range such that the occupants of the building structure may view his/her surroundings through the window. The film may have a layer of silver which reflects the solar radiation in the near and mid infrared ranges. Since the silver is susceptible to oxidation and turns the silver into a black body which absorbs the near and mid infrared radiation, a protective layer on the exterior of the infrared reflecting layer may be designed to slow the rate of oxidation of the silver layer to an acceptable level. The silver layer may be sandwiched between the glass which does not allow oxygen to diffuse there through and reach the layer of silver and the protective layer having a certain thickness which slows down the rate of oxygen diffusion to an acceptable level.

### CROSS-REFERENCE TO RELATED APPLICATIONS

This application is a continuation in part application of U.S. patent application Ser. No. 12/503,686, filed Jul. 15, 2009, the entire contents of which is expressly incorporated herein by reference.

### STATEMENT RE: FEDERALLY SPONSORED RESEARCH/DEVELOPMENT

Not Applicable

### BACKGROUND

The present invention relates to a building structure having a film mounted to its window for reducing solar radiation load and retaining heat within the building structure.

In warm and humid climates, direct sunlight on the building structure may cause its occupants to use the air conditioning system and/or use the air conditioning system at a higher level. Unfortunately, the air conditioning system may waste a large percentage of energy due to solar gain. By way of example and not limitation, it is believed that about 5% of the entire energy consumption in the United States is related to unwanted heat gain or loss through residential windows. High efficiency window systems have been developed such as triple or quadruple glazing window systems. Unfortunately, these systems add significant weight and cost to the window system. As a result, they have not received widespread adoption. In support thereof, these systems are believed to account for less than one percent of today's window sales. Additionally, the labor and material costs to retrofit existing homes with these high efficiency windows is believed to be excessively high (e.g., over $30,000 per home) in comparison to its energy efficiency benefits.

Several factors determine the comfort level within the building structure. They include the air temperature, air speed within the building structure, humidity of the air within the building structure and the amount of thermal radiation entering the building structure such as through the window. When the air temperature is uncomfortably hot, the occupants may turn on the air conditioning system to cool down the average air temperature. In this instance, the air conditioning unit consumes energy to reduce the air temperature within the building structure. The occupants may also turn on and/or increase fan speed to increase air speed of the air circulating within the building structure. The fan consumes energy. The speed of air within the building structure increases evaporation of moisture on the skin of the occupants which cools the occupant's skin temperature.

During the day, the building structure is exposed to solar radiation. A portion of the solar radiation is absorbed by the window and heated. For example, a large portion of the near infrared radiation and all of the mid infrared radiation are absorbed by the window and re-radiated into the interior of the building structure. The heated window re-radiates heat into the building structure to thereby increase the interior of the building structure's air temperature and heats up the interior of the building structure. A portion of the solar radiation is transmitted through the window and absorbed by the interior of the building structure (e.g., appliances, sofas, furniture, etc.). Upon absorption, the interior of the building structure re-radiates the absorbed energy into the air within the building structure. This further increases the air temperature within the building structure. The hot air and the hot interior of the building structure re-radiates energy generally as infrared radiation in the mid infrared range. Unfortunately, glass windows generally do not allow the mid infrared radiation to pass therethrough. As such, the mid infrared radiation is retained within the building structure and increases a temperature of the building structure above ambient temperature.

A portion of the solar radiation transmitted through the window may also be absorbed by the occupant's skin. This portion of the sun's rays may cause the occupants to feel uncomfortably hot thereby encouraging use of the air conditioning system even if the air temperature is within a comfortable range. This may cause the occupant to turn on the air conditioning system and/or fan. Use of the air conditioning system and the fan both consume energy. Any reduction in the use of the air conditioning system and fan would also reduce the total amount of consumed energy.

The human skin contains receptors that are sensitive to thermal radiation in the infrared range. When the occupants of the building structure are exposed to infrared radiation, the occupants may be uncomfortable even if the air temperature within the building structure is within a comfortable range. The occupants may resort to decreasing the average air temperature within the building structure and increasing the air speed of the fan system to counteract the discomfort caused by thermal radiation, both of which consume increasing amounts of energy.

Conversely, during the winter months, heat is lost through the windows of the building structure. In particular, objects within the building structure are heated by the heating system, fireplace, body heat, etc. The heated objects emit thermal radiation in all directions including toward the window of the building structure. This thermal radiation may be absorbed by the window and reradiated out of the building structure thereby increasing the heating needs of the building structure.

Heat may also be introduced into the building structure through thermal conductivity. By way of example and not limitation, the hot ambient air may contact the windows of the building structure. If the interior temperature of the building structure is cooler than the temperature of the hot ambient air, then the windows thermally conduct the heat from the exterior to the interior of the building structure. This would increase the air conditioning needs of the building structure. Conversely, heat may be lost from the building also through thermal conductivity. By way of example and not limitation, when the ambient temperature outside the building structure is cold, it is desirable to maintain the inside temperature of the building structure at a comfortable level. Unfortunately, the warmer inside air of the building structure contacts the windows of the building structure. The windows may thermally conduct heat from within the building structure to the exterior of the building structure. This would raise the heating needs of the building structure.

As such, there is a need in the art for an apparatus and method for reducing the need to use the air conditioning system and/or fan of the building structure's cooling system and reducing occupant exposure to solar infrared radiation. Additionally, there is a need in the art for an apparatus and method for retaining thermal radiation within the building structure to retain heat and reduce the load on the building structures heating system due to loss of thermal radiation. There is also a need to provide additional thermal insulation to the windows of the building structure.

### BRIEF SUMMARY

The present invention addresses the needs discussed above, discussed below and those that are known in the art.

A building structure is provided having a high efficiency solar control system. The solar control system may comprise a glass sheet and a film mounted to its exterior side, namely, the side closer to the environment. The glass and film may define a window (e.g., bedroom window, backdoor window, etc.) of the building structure. The film may have high transmission of light in the visible range such that the occupants of the building structure may view his/her surroundings through the window. Also, the film may reflect a high percentage of light in the near infrared range and the mid infrared range back into the environment. As such, during the summer months, the solar load on the building structure is reduced by the amount of solar radiation in the near infrared range and the mid infrared range reflected back into the environment.

Conversely, when the ambient outside temperature is uncomfortably cold such as during the winter months or night time, the film may be operative to reflect thermal radiation emanating from within the building structure back into the building structure to retain heat within the building structure and reduce a load on the building structure's heating system. As previously discussed, the heated objects within the building structure and the occupants emanate thermal radiation in all directions. This thermal radiation includes infrared radiation in the near, mid and far infrared ranges. This thermal radiation may be directed toward the windows of the building structure. A portion of the thermal radiation is absorbed by the glass of the window and re-radiated back into the interior of the building structure. A portion of the thermal radiation may be absorbed by the glass and re-radiated toward the film. Fortunately, the film reflects substantially all of the reradiated thermal radiation in the mid and far infrared ranges and about half in the near infrared range back to the glass which absorbs the reflected thermal radiation and re-radiates the thermal radiation back into the interior of the building structure. The film provides an infrared radiation barrier to mitigate loss of thermal radiation from within the building structure when needed and to reduce entrance of solar infrared radiation into the building structure.

There may also be a gap between the film and the window to insulate the window. The gap may be filled with air which may be dehumidified or gas (e.g., nitrogen, krypton, argon, etc.). The gap may form a layer of gas between the film and the window. The film and gap may provide a thermal insulation barrier in addition to the insulation provided by the window glass or material. When the outside temperature is uncomfortably hot, then the film and gap provides a thermal insulation barrier such that less heat from the exterior of the building is thermally conducted into the building structure through the window. Conversely, when the outside temperature is uncomfortably cold, then the film and gap provides a thermal insulation barrier such that less heat from the interior of the building is thermally conducted out of the building structure through the window.

The film may optionally have a plurality of sacrificial layers which have a high transmission value with respect to the visible range and the near and mid infrared ranges. The topmost sacrificial layer may be removed or peeled away when it has been unacceptably degraded due to environmental elements (e.g., chips, oxidation, etc.) thereby exposing a fresh new topmost layer. Additionally, the additional sacrificial layers mitigate oxidation of a silver layer embedded within the film. In particular, the film is mounted to glass of the window. As such, one side of the film does not allow diffusion of oxygen into the film since oxygen cannot diffuse through the glass. On the other side of the film (or the silver layer(s)), a thick stack of sacrificial layers may be formed. Although oxygen may be diffused through the sacrificial layers, such diffusion of oxygen through the sacrificial layers may be slowed down by increasing the thickness of the sacrificial layers. Either or both the number of sacrificial layers may be increased or decreased as appropriate or the thickness of each of the sacrificial layers may be increased or decreased to bring the rate of oxygen diffusion to an acceptable level. The silver layer is disposed between the glass and the thick stack of sacrificial layers which protects the silver layer from oxidation. It is also contemplated that a single protective layer may cover the silver layer to mitigate oxidation of the silver layer instead of incorporating the plurality of sacrificial layers as discussed above. The protective layer may be sufficiently thick or impermeable to oxygen to slow down the rate of oxidation of the silver layer to an acceptable level.

A building structure for sheltering people from an environment is disclosed. The building structure may comprise a glass window defining an interior side and an exterior side, a film disposed on the exterior side of the glass window for reflecting infrared radiation away from the glass window and for reflecting thermal radiation back into the building structure, and an adhesive layer between the film and the glass window for adhering the film to the glass window wherein the adhesive layer is disposed along a peripheral edge portion of the film for forming a gap between the glass window and the film. The gap may be disposed interior to the peripheral edge portion of the film. The film and gap reduces the coefficient of thermal conductivity through the window.

The film may comprise an infrared reflecting layer. The infrared reflecting layer may define an interior side and an exterior side. The interior side of the infrared reflecting layer may be attached to the exterior side of the glass window. The infrared reflecting layer may have an embedded infrared reflecting core which comprises one or more layers of silver and one or more layers of dielectric for reflecting infrared radiation. The infrared reflecting layer may also comprise a first protective layer attached to the exterior side of the infrared reflecting core for mitigating oxidation of the silver layer. One or more additional second protective layers may be removeably attached to the first protective layer for providing a sacrificial top layer which can be removed when damaged. The second protective layers are optional.

The adhesive layer may further comprise an elongate strip extending between opposed sides of the film. The adhesive of the adhesive layer may be an ultraviolet light absorbing adhesive. The infrared reflecting layer may be generally transparent to visible spectrum of light. The infrared reflecting layer may be fabricated from biaxially-oriented polyethelene terephthalate. The silver and the dielectric layers discussed above may alternate. The second protective layers which are optional may be peelably adhered to one another. An exterior side of each of the first and second protective layers may have an ultraviolet light absorbing hard coat. The first and/or second protective layers may be sufficiently thick to reduce the rate of oxidation of the silver layer to a level such that the film has a sufficiently useful long life. The first and second protective layers may be fabricated from biaxially-oriented polyethelene terephthalate.

A method for reducing an amount of solar radiation entering a building structure and for increasing insulation value of a window of the building structure is disclosed. The method may comprise the steps of providing a film for reflecting infrared radiation, attaching a peripheral edge portion of the film to an exterior side of a glass window, and forming a gap between the film and the glass window wherein the film and gap reduces a coefficient of thermal conductivity through the window. The film may comprise an infrared reflecting layer defining an interior side. The infrared reflecting layer may include an infrared reflecting core with a first protective layer attached to the infrared reflecting core. The first protective layer may mitigate oxidation of the silver layer. Additional second protective layers may be attached to the protective layer for providing a sacrificial top layer which can be removed when damaged due to UV exposure or oxidation. The additional second protective layers are removeably attached to each other and are optional.

The attaching step may comprise the step of adhering the interior side of the infrared reflecting layer to the exterior side of the glass window. The method may further comprise the step of providing a stack of sacrificial layers removeably attached to each other such that a top most sacrificial layer may be removed and discarded when the top most protective layer is damaged due to ultraviolet light exposure or oxidation; and mounting the stack of sacrificial layers to the infrared reflecting layer. The step of providing a stack of sacrificial layers and mounting the same are optional.

A building structure is also disclosed which comprises a glass window defining an interior side and an exterior side, a film attached to the exterior side of the glass window for reflecting infrared radiation away from the glass window to an exterior of the building structure and for reflecting thermal radiation back into an interior of the building structure, and an adhesive layer disposed between the film and the glass window for adhering the film to the glass window. The film may comprise an infrared reflecting core which comprises one or more layers of silver and one or more layers of dielectric for reflecting infrared radiation wherein the infrared reflecting core defines opposed first and second sides, first protective layers are attached to the first and second sides of the infrared reflecting layer wherein the first protective layer attached to the first side of the has a first thickness and the first protective layer attached to the second side of the infrared reflecting layer has a second thickness wherein the first thickness is greater than the second thickness. The first and second protective layers provide structural support to the one or more silver layers. Also, the thicker first protective layer mitigates oxidation of the one or more silver layers caused by oxygen diffusion through the first protective layer. The adhesive layer may be disposed along a peripheral edge portion of the film for forming a gap between the glass window and the film interior to the peripheral edge portion of the film wherein the gap reduces the coefficient of thermal conductivity through the window.

The building structure may further comprise a stack of sacrificial layers attached to the first protective layer and removeably attached to each other such that a top most sacrificial layer may be removed and discarded when the top most sacrificial layer is damaged due to ultraviolet light exposure or oxidation. The stack of sacrificial layers is optional. The sacrificial layers may be adhered to each other. The first thickness may be sufficiently thick to reduce the rate of oxidation of the silver layer to a level such that the film has a sufficiently long useful life.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 illustrates a building structure having a high efficiency solar control system;

FIG. 2 is an enlarged view of a window shown in FIG. 1;

FIG. 3 is a cross-sectional view of the window shown in FIG. 2;

FIG. 4 is an enlarged view of the window shown in FIG. 3;

FIG. 4A is a cross sectional view of a prior art building structure window without an absorption film;

FIG. 4B is a cross sectional view of the prior art building structure window with an absorption film;

FIG. 5 is a detailed enlarged view of the window shown in FIG. 3;

FIG. 6 illustrates an alternate embodiment of the film shown in FIG. 5;

FIG. 7 illustrates an alternate embodiment for forming a gap between the film and the glass window; and

FIG. 8 illustrates thermal radiation emanating from within a building structure being absorbed by a glass window and being reflected back into an interior of the building structure by a film having an infrared reflecting core.

### DETAILED DESCRIPTION

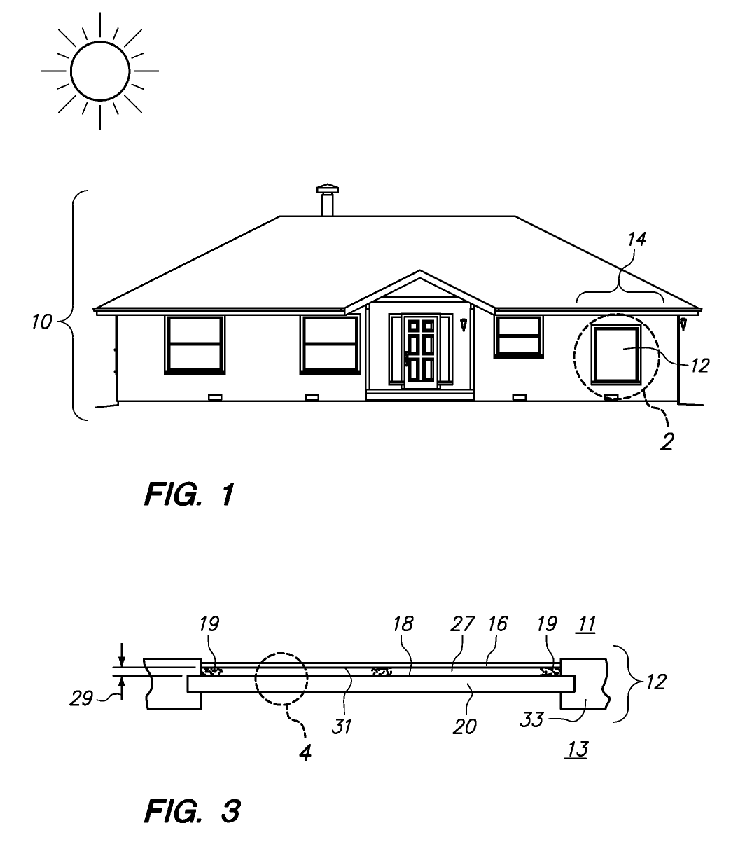

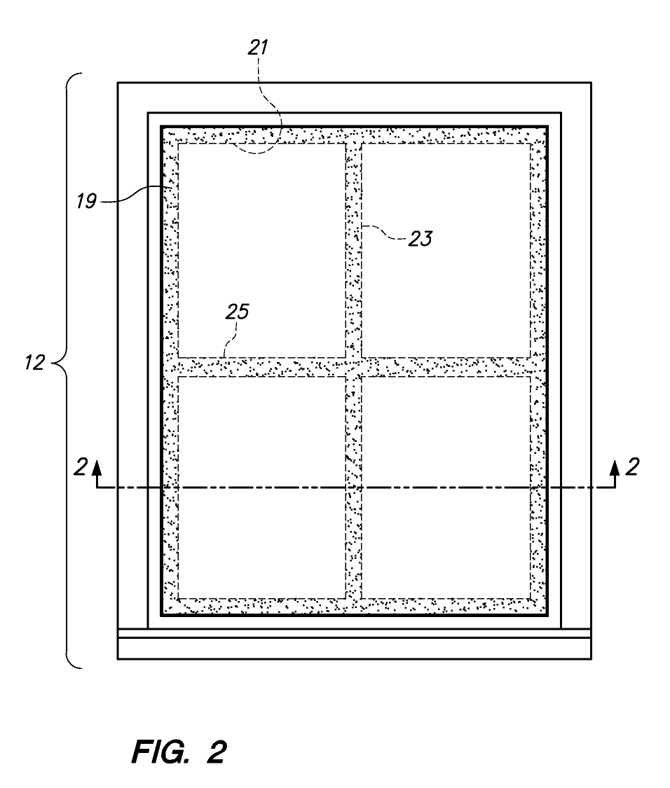

Referring now to FIG. 1, a building structure 10 having a window 12 is shown. The window 12 protects the occupants from environmental elements (e.g., wind, rain, etc.) yet allows the occupants to view the surroundings from within a room 14 of the building structure 10. FIG. 2 is an enlarged view of the window 12 shown in FIG. 1. As shown in FIGS. 2 and 3, the window 12 may have a film 16 attached to an exterior side 18 of a glass 20 of the window 12. For example, as shown in FIG. 3, the film 16 may be attached to the exterior side 18 of the glass 20 at its outer periphery 21 with adhesive 19. Adhesive 19 may also be disposed at selective areas within the outer periphery such as vertical area 23 and horizontal area 25 (see FIG. 2). Since the adhesive 19 is not continuously disposed on the film 16, a gap 27 (see FIG. 3) is formed between the film 16 and the glass 20 of the window 12. The film 16 and gap 27 provide a thermal insulation barrier to reduce thermal conductivity of heat through the window 12 in addition to the glass window 12 itself.

Additionally, the film 16 may be generally optically transparent in the visible wavelengths and generally reflect radiation in the non-visible or infrared wavelengths. The sun's rays transmit solar radiation both in the visible light range and also in the infrared range. A majority of the radiation in the infrared range may be reflected back to the exterior 11 of the room 14 or the building structure 10 by the film 16. A small portion of the energy may be transmitted into the room 14 through the glass 20 of the window and a small portion is absorbed by the glass 20, converted into heat and re-radiated into the interior 13 of the room 14. Beneficially, the film 16 reduces the amount of solar radiation in the near and mid infrared ranges from entering into the room 14 or the building structure 10 by reflecting a large percentage back to the environment. As such, the amount of solar radiation introduced into the air of the room 14 or building structure 10, absorbed into the interior of the room 14 and contacting the occupant's skin is reduced. This lowers the average air temperature within the room 14 or the building structure 10. This also reduces discomfort of the occupants due to exposure to infrared radiation when the occupant is in the line of sight of the sun. Beneficially, the film 16 increases the occupant's comfort with respect to temperature.

Conversely, during colder months, it is desirable to retain heat within the building structure 10. Since the film 16 is disposed on the exterior side of the glass 20 of the window 12 with a gap 27, heat is retain within the building structure in at least two ways. First, the film 16 and gap 27 provides a thermal insulation barrier as discussed above to prevent loss of heat through the window 12 via thermal conductivity. Also, the film 16 reflects back thermal radiation back into the interior 13 of the building structure 10. In particular, the objects and occupants within the building structure 10 emanate thermal radiation in all directions including toward the windows. This thermal radiation is reflected by the film 16 back into the building structure 10. The film 16 provides an infrared radiation barrier.

As will be discussed further herein, the film 16 is mounted to an exterior of the glass 20 of a window 12 of a building structure 10 to reduce solar radiation load. Also, the film 16 reflects infrared radiation to retain thermal radiation within the building structure 10. Moreover, the film 16, film 16 in conjunction with gap 27 or the gap 27 mitigates loss of heat or heat gain within the building structure through thermal conductivity when desirable.

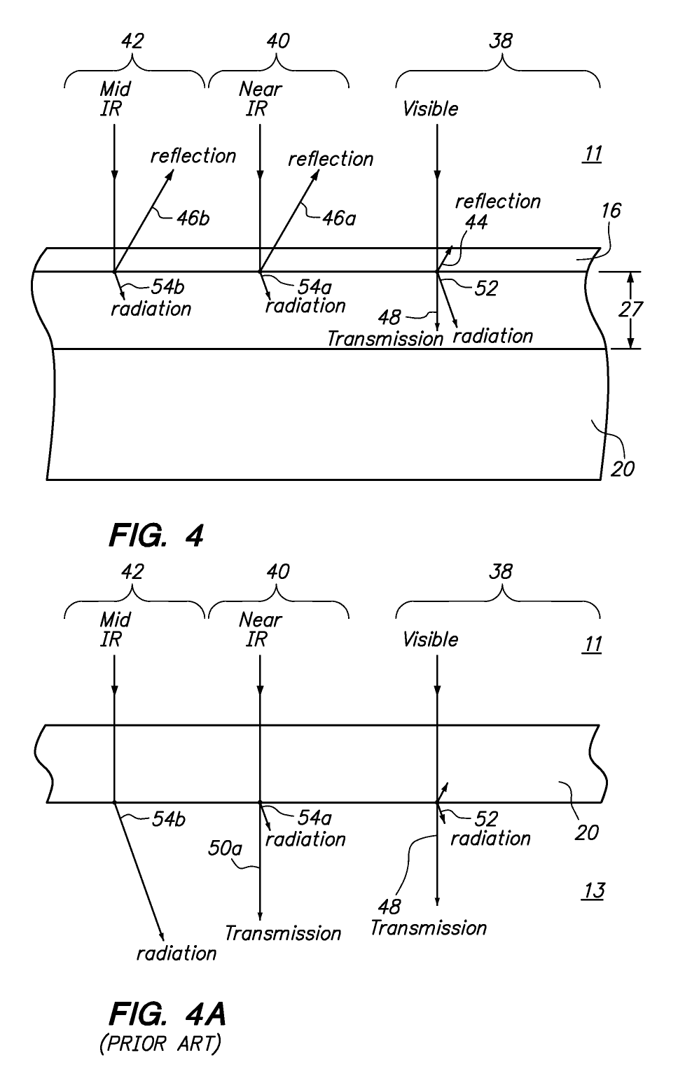

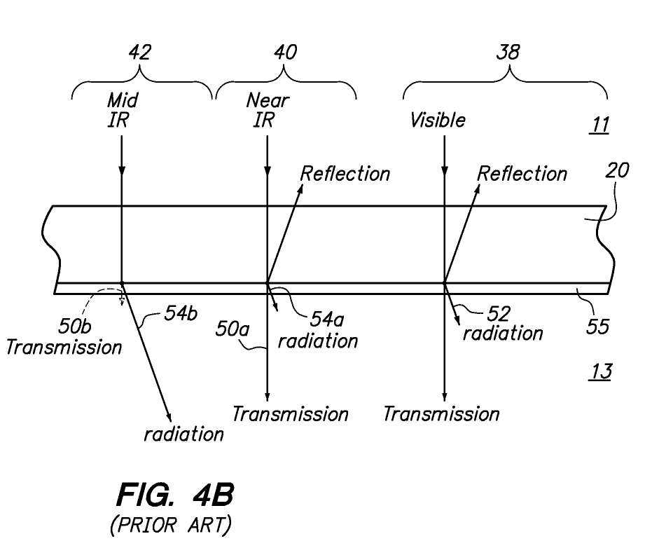

Referring now to FIG. 4, solar radiation may be divided into the visible range 38, near infrared range 40, and the mid-infrared range 42. For each of these ranges 38, 40, 42, a portion of the solar radiation is transmitted through the film 16 and a portion of the solar radiation is reflected back to the exterior 11 of the room 14 or the building structure 10 as shown by arrows 44, 46a, b. In the visible range 38, a large percentage (i.e., more than 50%, but preferably about 70% or more) of the light is transmitted through the film 16. In contrast, in the near infrared range 40 or the mid infrared range 42, a large percentage (i.e., more than 50% but preferably about 80% or more) of the light is reflected back to the exterior 11 of the room 14 or building structure 10. Since the film 16 is mounted to the exterior of the glass 20, less of the near infrared radiation 40 and the mid infrared radiation 42 reaches the glass 20 compared to the prior art as shown by comparing FIG. 4 with FIGS. 4A and 4B. FIG. 4A illustrates untreated glass 20. FIG. 4B illustrates glass 20 with a commonly used absorption film 55 mounted to the interior or inside of the glass 20. In FIG. 4B, the reflected mid infrared radiation may be absorbed by the glass 20. In certain cases, the heat from the absorbed mid infrared radiation may detrimentally affect (e.g., break) the glass 20 and/or blow out the seal of a dual pane window system. The lengths of the lines 54a, b and 50a which generally indicates magnitude of transmission and radiation is longer in FIGS. 4A and 4B compared to FIG. 4. As shown, the glass 20 is heated to a lesser extent and the amount of near IR radiation 40 transmitted through the glass 20 is less with use of the film 16 mounted to the exterior of the glass 20 such that the heat load on the building structure 10 and occupant exposure to near infrared radiation 40 is reduced. This promotes less or no use of the air conditioning system and/or fan.

For that portion of the solar radiation transmitted through the film 16, a portion is transmitted through the glass 20 in the visible range as shown by arrow 48. The remainder is absorbed into the glass 20 thereby heating the glass 20 and reradiated as thermal radiation into the interior 13 of the room 14 or building structure as shown by arrows 52, 54a, b. Generally for residential glass, all of mid infrared radiation 42 is absorbed by the glass 20 and reradiated into the interior 13 of the room 14 or building structure as shown by arrow 54b. However, it is contemplated that other glass compositions may be employed for building structures such that a portion of the mid infrared radiation 42 may be transmitted through the glass 20. The film 16 has a high percentage (i.e., more than 50% but preferably about 70% or more) of transmission 48 of the solar radiation in the visible range 38 and a high percentage (i.e., more than 50% but preferably 80% or more) of reflection 46a, b in the near-infrared range 40 and the mid-infrared range 42. The film 16 also reflects a portion of the solar radiation in the far infrared range (not shown).

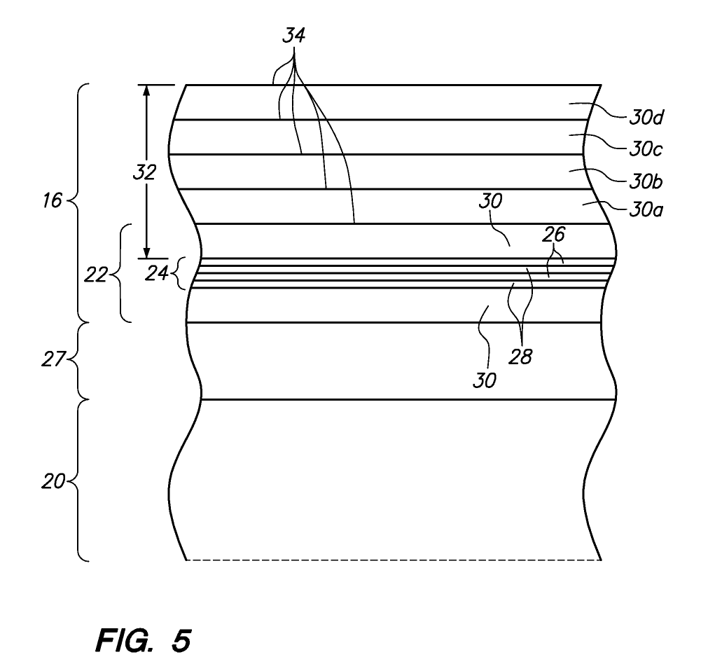

Referring now to FIG. 5, an enlarged cross-sectional view of film 16 and glass 20 with gap 27 is shown. The film 16 may have an infrared reflecting layer 22 with an embedded infrared reflecting core 24. The infrared reflecting core 24 may comprise one or more silver layers 26 and one or more dielectric layers 28. The silver layer 26 and the dielectric layer 28 may alternate such that the infrared reflecting core 24 may comprise a layer of dielectric 28, a layer of silver 26, a layer of dielectric 28, a layer of silver 26, a layer of dielectric 28 all stacked upon each other. Preferably, the dielectric layers 28 are the outermost layers of the embedded infrared reflecting core 24. At a minimum, one silver layer 26 is disposed between two layers of dielectric 28. The silver layers 26 and dielectric layers 28 may have a thickness measured in nanometers. The silver layer 26 may be generally transparent in the visible range and reflect a high percentage of infrared radiation especially in the near infrared range 40 and the mid infrared range 42. The number and thickness of silver layers 26 and the number and thickness of dielectric layers 28 may be adjusted to tune the amount or percentage of infrared radiation being reflected by the infrared reflecting core 24.

The infrared reflecting core 24 may be sandwiched between two layers 30 of material having high transmission (i.e., greater than 50% but preferably about 90% or more) both in the visible range and the near and mid infrared ranges. By way of example and not limitation, the layer 30 may be biaxially-oriented polyethelene terephthalate (hereinafter “BoPET”) mylar. BoPET is the preferred material since it is dimensionally stable (i.e., not elastic), has a high transmission in the visible and near and mid infrared ranges, low scatter and low cost. The dimensionally stability of the BoPET layer 30 provides support for the silver layer 26. Otherwise, the silver layer 26 may crack or become damaged upon stretching of the layer 30. Additionally, the infrared reflecting layer 22 is useful for reflecting a high percentage (i.e., more than 50% but preferably about 70% or more) of solar thermal radiation in the near and mid infrared ranges 40, 42 and allowing light in the visible range 38 to be transmitted through the BoPET layers 30 and the infrared reflecting core 24.

One of the characteristics of the silver layer 26 is that upon exposure to oxygen, the silver oxidizes as a black material. In the oxidation process, the silver is converted from a material that reflects heat in the near to mid infrared ranges 40, 42 to a black body that absorbs heat in the near to mid infrared ranges 40, 42. Instead of reflecting a majority of the heat in the near and mid infrared ranges 40, 42, the silver layer 26 now absorbs radiation in both the visible range 38 and the near and mid infrared ranges 40, 42. Detrimentally, the silver layer 26 absorbs and re-radiates such energy into the building structure 10. Additionally, one of the characteristics of the BoPET layer 30 is that oxygen diffuses through the BoPET layer 30 such that oxygen ultimately reaches the silver layer 26 and oxidizes the same 26. To prevent or reduce the rate of oxidation of the silver layers 26 to an acceptable rate, additional layers 30a-d may be stacked on the infrared reflecting layer 22. Any number of layers 30a-n may be stacked on the infrared reflecting layer 22. The amount of oxygen diffused through the layers 30a-n and 30 is a function of a distance 32 from the silver layer 26 and the exterior side 34 of the topmost layer 30. The amount of oxygen reaching the silver layer 26 from an exterior side (i.e., from outside the building structure 10) is reduced since the oxygen must travel a greater distance through the layers 30a-n and 30. On the interior side, the film 16 is mounted to the glass 20 which protects the silver layer(s) 26 from oxidation. Oxygen does not pass through the glass 20.

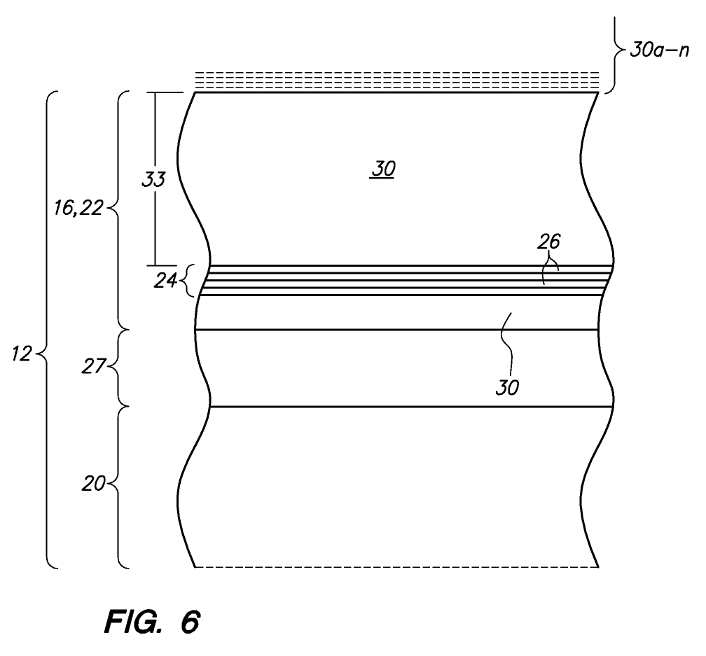

Alternatively, it is contemplated that the thickness 33 of the BoPET layer 30 in the infrared reflecting layer 22 may be increased (see FIG. 6) to slow down the rate of oxidation of the silver layers 26 to an acceptable level. Optionally, an additional stack of BoPET layers 30a-n may be adhered to the BoPET layer 30 on the exterior side, as shown in dash lines in FIG. 6. The stack of BoPET layers 30a-n may be removably adhered to each other such that the topmost BoPET layer 30a-n may be used as a sacrificial top layer as discussed herein. In the embodiment shown in FIG. 6, the additional stack of BoPET layers 30a-n is optional. As such, when the infrared reflecting layer 22 is used without the additional stack of BoPET layers 30a-n, BoPET layer 30 may provide the primary means to slow down the rate of oxidation of the silver layer 26 to an acceptable level. There are no sacrificial layers of BoPET layers 30a-n adhered to the BoPET layer 30. Various aspects of the film 16 discussed herein is in relation to an infrared reflecting layer 22 with a stack of additional BoPET layers 30a-n which serve as sacrificial layers. However, the various aspects may also be employed with the infrared reflecting layer 22 without the additional BoPET layers 30a-n. Accordingly, as used herein, the term “film” 16 refers to both the infrared reflecting layer 22 with or without the sacrificial layers 30a-n.

The adhesive 19 may define an adhesive layer 29 which is initially disposed on an exposed side 31 as shown in FIG. 3. When the film 16 is mounted to the window 12, the adhesive layer 29 is disposed between the film and the glass 20 of the window 12. Referring back to FIG. 2, the adhesive 19 may be disposed at selective areas on the exposed side of the infrared reflecting layer 22. In FIG. 2, the adhesive 19 is disposed on the outer periphery 21 to mitigate oxygen from seeping between the film 16 and the window and oxidizing the silver layer 26. The adhesive 19 at the outer periphery 21 of the film 16 may be an adhesive or other material that prevents diffusion of oxygen or air through the adhesive 19 or other material to prevent entrance of air into the gap 27 between the film and the glass 20. Alternative methods of sealing the outer periphery of the film 16 are contemplated. By way of example and not limitation, a seal (e.g., silicone, rubber, etc.) may be disposed between the film 16 and the glass 20 of the window 12. A frame 33 of the window may clamp the outer periphery 21 of the film 16 on the glass 20 of the window 12. Essentially, the seal provides an airtight seal such that oxygen or air cannot seep between the film 16 and the glass 20 so as to oxidize the silver layer 26. The thickness of the adhesive 19 and/or seal defines the size of the gap 27. To enlarge the gap 27, more adhesive 19 or a thicker seal is utilized. Conversely, to reduce the gap 27, less adhesive 19 or a thinner seal is utilized. The gap 27 may be about 0.002 inches wide or more as measured from the film 16 to the glass 20. The thermal insulation benefits of the gap 27 increases as the gap 27 is enlarged. However, it has been found that the thermal insulation benefits of the gap 27 are still effective at the lower range. Adhesive may be selectively placed interior to the outer periphery 21. As shown in FIG. 2, vertical and horizontal strips 23, 25 of adhesive 19 have been disposed on the film 16. Other configurations, shapes and patterns are also contemplated. By way of example and not limitation, small dots or patches (e.g., circular, square, triangular, etc.) may be laid down on the exposed side 31 of the infrared reflecting layer 22.

Referring back to FIG. 5, during use, the exterior side 34 of the topmost layer 30d is exposed to environmental elements such as rain (containing chemicals), rocks, dirt, ultraviolet light, etc. As such, the exterior side 34 of the topmost layer 30d may experience physical degradation (e.g., chips, oxidation, etc.). It may be difficult to see through the film 16 due to the degradation of the topmost layer 30d. Beneficially, each of the layers 30a-d may be removed (e.g., peeled away) from each other and also from the infrared reflecting layer 22. The then topmost layer behaves as a sacrificial layer which is removed when it has been unacceptably degraded by the environmental elements. To this end, the layer 30d may be peelably adhered to layer 30c, layer 30c may be peelably adhered to layer 30d, layer 30d may be peelably adhered to layer 30a and layer 30a may be peelably adhered to the infrared reflecting layer 22. A tab or other means of removing the topmost layer 30d may be provided such that the topmost layer 30d may be peeled off of the adjacent lower layer 30c when the topmost layer 30d is unacceptably degraded. Upon further use, the new top layer 30c experiences physical degradation. When the then topmost layer 30c is degraded to an unacceptable level, the topmost layer 30c is now peeled away from the top layer 30b. The process is repeated for layers 30b and 30a. As the topmost layers 30d, c, b, a are peeled away, the rate of oxidation of the silver layer 26 increases. As such, the number of layers 30a-n may be increased or decreased based on the required useful life of the film 16. To extend the useful life of the film 16, additional layers 30a-n are stacked upon each other to increase the distance 32. Conversely, to decrease the useful life of the film 16, fewer layers 30a-n are stacked upon each other to decrease the distance 32. When the silver layer 26 is unacceptably oxidized, the entire film 16 is removed from the glass 20 and a new film 16 is mounted to the exterior surface 36 of the glass 20.

Each of the BoPET layers 30a-d and 30 may define an exterior side 34. An ultraviolet light absorbing hard coat may be coated onto the exterior side 34 of the BoPET layers 30a-d and 30 to slow the damaging effects of ultraviolet light on the BoPET layer 30. Additionally, the adhesive for attaching the BoPET layers 30a-d to each other as well as the adhesive for adhering the BoPET layer 30a to the infrared reflecting layer 22 may be an ultraviolet light absorbing adhesive to further slow the damage of ultraviolet light exposure. Such adhesives may continuously cover most if not all of the BoPET layer 30a-d and the infrared reflecting layer 22.

A method for attaching the film 16 to the glass window 20 will now be described. Initially, the film 16 is provided. The film 16 may have a peelable protective liner on both sides to protect the silver layers 26 from oxidation and the exterior surfaces from oxidation as well as chipping prior to installation and during storage. The protective liner may be impermeable to oxygen to prevent oxidation of the exterior surfaces of the film 16 as well as oxidation of the silver layers 26. The protective liner may also block ultraviolet light to mitigate damage to the film 16 in the event the film 16 is left out in the sun. The protective liner may be adhered to the exterior surfaces of the film 16 in a peelable fashion. Prior to mounting the film 16 to the glass 20, the film 16 may be cut to the size of the building structure window. After the film 16 is cut to size, the protective liner may be peeled away to expose the film 16. The exposed side of the film 16 may have a pressure sensitive adhesive. The pressure sensitive adhesive may cover selective portions of the exposed side of the film 16. The exterior side of the glass 20 may be cleaned to allow the pressure sensitive adhesive to stick to the exterior side of the glass 20 The cut film 16 may now be laid over the exterior side of the window 12. The adhesive may be set such that the film 16 is mounted to the glass 20 and the film 16 cannot slip with respect to the glass 20.

The film 16 may be attached to the glass 20 in a clean room with dehumidified air to mitigate condensation during ambient temperature changes. Additionally, it is contemplated that the film 16 may be attached to the glass window 20 in a gas (e.g., argon, krypton, etc.) filled chamber. In this manner, the gas disposed between the film 16 and the glass window 20 may be selective so as to mitigate oxidation of the silver layer 26 and condensation. In a further alternative method, an input port (e.g., needle) and an output port (e.g., needle) may be formed on the film 16 and/or the glass 20. The gas may be flowed through the input port, through the gap 27 and out through the output port until the moist air is removed from within the gap 27.

The film 16 may be fabricated in the following manner. Initially, a BoPET layer 30 is provided as a roll. The BoPET layer 30 is unrolled and a layer of dielectric 28 is formed on one side of the BoPET layer 30. The thickness of the BoPET layer 30 may be between approximately 0.001 inch to approximately 0.007 inch thick and may preferably be about two thousandths of an inch thick. The thickness of the dielectric layer 28 may be measured in nanometers. As the layer of dielectric 28 is laid on one side of the BoPET layer 30, the BoPET layer 30 is rerolled. The BoPET layer 30 is then unrolled such that a layer of silver 26 may then be laid on top of the layer of dielectric 28. The silver layer 26 is also measured in nanometers and is extremely thin. The BoPET layer 30 is rolled back up and unrolled a number of times until the desired number of silver and dielectric layers 26, 28 is attained. A second BoPET layer 30 (about 0.002 inches thick) may be laminated onto the dielectric layer 28 such that two BoPET layers 30 sandwich the alternating layers of silver 26 and dielectric 28 which form the infrared reflecting core 24. Thereafter, additional layers of BoPET 30a-n (each layer being about 0.002 inches thick) may be laminated onto the infrared reflecting layer 22 to serve as a sacrificial layer and reduce the rate of oxygen diffusion. As discussed above, the additional layers of BoPET 30a-n are optional. The adhesive layer 19 may be screened onto an exposed side of the infrared reflecting layer 22. Optionally, protective layers for protecting the film 16 during storage and prior to installation may be laminated onto opposed sides of the film 16. The thickness of the film 16 may be limited by the amount of bending required to roll the film 16 during manufacture. For thicker films 16, it is contemplated that the film 16 may be fabricated in a sheet form process.

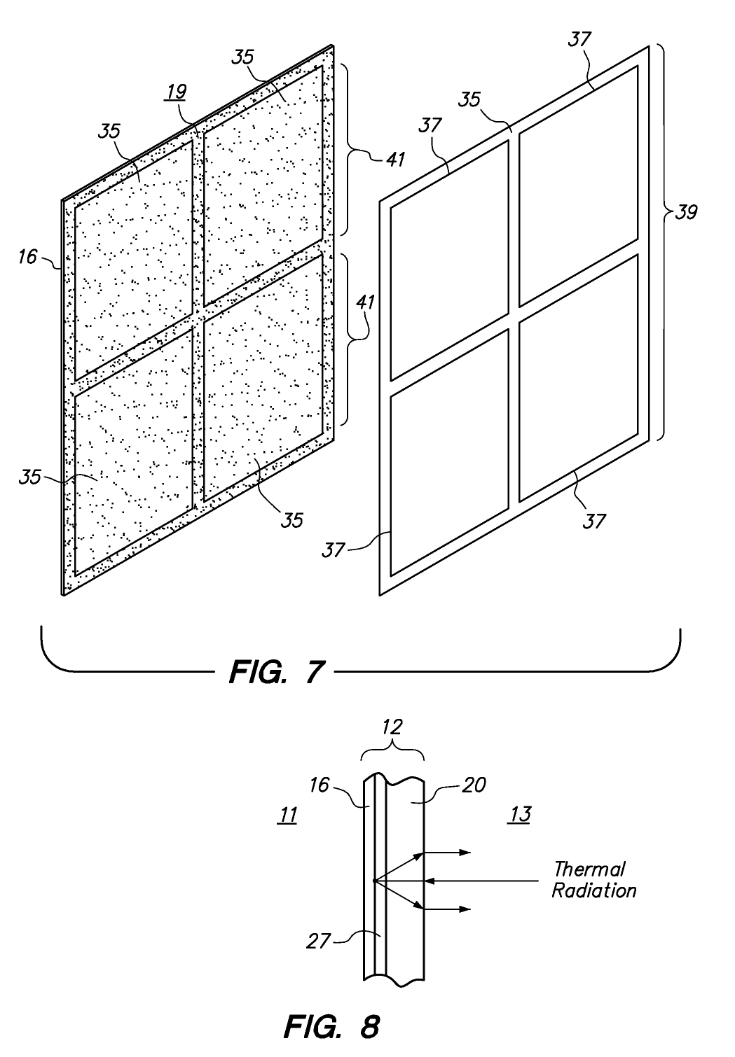

Referring now to FIG. 7, an alternate method of fabricating the film 16 is illustrated. In particular, the infrared reflecting layer 22 and the additional BoPET layers 30a-n may be formed as described above. The adhesive layer 19 may continuously cover the exposed side of the film 16. Thereafter, a protective removeable liner 35 may be attached to the adhesive layer 19 to protect the adhesive layer 19 during storage and transport. The protective removeable liner 35 may be cut in the pattern shown in FIG. 7 or any other pattern as desired. In FIG. 7, the laser cuts four rectangular shapes 37. When the film is ready to be mounted to the window 12, a portion 39 of the protective removeable liner 35 is removed from the film 16 exposing a portion of the adhesive. However, a portion 41 of the protective removeable liner 35 is still attached to the film 16. The film 16 is now adhered to the window. An air gap 27 is formed between the portion 41 of the protective liner 35 and the glass 20 of the window.

Referring now to FIG. 8, thermal radiation emanates from within the building structure 10. The source of the thermal radiation within the building structure 10 may be the occupant's body heat, a light bulb, stove, heat from objects, etc. Generally, thermal radiation emits infrared radiation in the near, mid and far infrared ranges. A portion of this radiated thermal radiation in the near, mid and far infrared ranges reaches the window 12 of the building structure 10. A portion of the thermal radiation is absorbed by the glass 20 of the window 12. A portion of the thermal radiation is transmitted through the glass 20 and gap 27 and reflected off of the film 16 or the infrared reflecting layer 22 back toward the interior 13 of the building structure 10. The film 16 or the infrared reflecting layer 22 may be effective to reflect a majority (i.e., more than 50% preferably 90%) if not all of the mid and far infrared radiation and approximately fifty(50)% of the near infrared radiation. Additionally, the thermal radiation absorbed by the glass 20 heats the glass 20 and emits thermal radiation in the near, mid and far infrared ranges toward the exterior 11 of the building structure 10 as well as the interior 13 of the building structure 10. For that portion of the thermal radiation transmitted toward the exterior 11 of the building structure 10, the film 16 reflects the thermal radiation in the mid and far infrared ranges to direct the thermal radiation back into the interior 13 of the building structure 10. As such, the film 16 retains the thermal radiation emanating from objects and people within the building structure 10.

The film 16 serves to provide a radiation barrier in both directions through the window 12. When the temperature inside the building structure needs to remain cooler than the outside temperature, the film 16 mitigates entrance of solar infrared radiation into the building structure. This typically occurs during the summer months. Conversely, when the temperature inside the building structure needs to remain warmer than the outside temperature, the film 16 mitigates loss of thermal radiation generated from within the building structure.

The film 16 and gap 27 provides a thermal insulation barrier in both directions through the window 12. The film 16 and gap 27 reduces thermal conductivity of heat through the window. For example, when the outside temperature is uncomfortably hot compared to the interior of the building structure, the heat of the hot air outside the building structure contacts the window of the building structure. The film 16 and gap 27 reduces the coefficient of thermal conductivity through the window 12 such that the heat external to the building structure remains outside. The cooling needs are reduced. Conversely, when the outside temperature is uncomfortably cold compared to the interior of the building structure, the heat of the warmer inside air contacts the windows. The film 16 and gap 27 reduce the coefficient of thermal conductivity through the window 12 such that the heat from the warmer inside air is not lost through the window 12 and remain inside of the building structure 10.

The BoPET material from which the film 16 is manufactured may have better thermal insulation characteristics compared to the glass 20 of the window 12 in that the BoPET material may insulate heat better than the glass 20. (e.g., about 5 times better). The gap 27 may also provide substantially better thermal insulation characteristics compared to both the BoPET material as well as the glass 20 of the window 12. As such, the thermal insulation characteristic of the window 12 is substantially improved over the glass 20 by itself by attaching the film 16 to the window 12 and/or by attaching the film 16 to the exterior of the window 12 with the gap 27. It is also contemplated that the film 16 may be manufactured by other material which may have equal or less desireable thermal insulation characteristics compared to the glass 20 of the window 12. In this situation, the gap 27 by itself still provides supplemental thermal insulation protection in addition to the thermal insulation protection provided by the glass 20.

The various aspects of the film 16 discussed herein was described and shown with respect to a single pane glass window 12. However, it is contemplated that the film 16 may be used in conjunction with other types of windows 12 such as a single pane window, dual pane window, triple pane window, windows manufactured from plastic, etc.

The above description is given by way of example, and not limitation. Given the above disclosure, one skilled in the art could devise variations that are within the scope and spirit of the invention disclosed herein, including various ways of adhering the film 16 to the glass 20. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A building structure for sheltering people from an environment, the building structure comprising:
a glass window defining an interior side and an exterior side;
a film disposed on the exterior side of the glass window for reflecting infrared radiation away from the glass window and for reflecting thermal radiation back into the building structure, the film comprising:
an infrared reflecting layer defining an interior side and an exterior side, the interior side of the infrared reflecting layer attached to the exterior side of the glass window, the infrared reflecting layer having an embedded infrared reflecting core which comprises one or more layers of silver and one or more layers of dielectric for reflecting infrared radiation and a first protective layer attached to the exterior side of the infrared reflecting core for mitigating oxidation of the silver layer;
an adhesive layer between the film and the glass window for adhering the film to the glass window, the adhesive layer disposed along a peripheral edge portion of the film for forming a gap between the glass window and the film interior to the peripheral edge portion of the film wherein the gap reduces a coefficient of thermal conductivity through the window.

2. The building structure of claim 1 wherein the infrared reflecting layer further comprises one or more second protective layers for providing a sacrificial top layer which can be removed when damaged due to UV exposure.

3. The building structure of claim 1 wherein the film has a lower coefficient of thermal conductivity compared to the glass window.

4. The building structure of claim 1 wherein the adhesive layer further comprises an elongate strip extending between opposed sides of the film.

5. The building structure of claim 1 wherein the infrared reflecting layer is generally transparent to visible spectrum of light.

6. The building structure of claim 1 wherein the infrared reflecting layer is biaxially-oriented polyethelene terephthalate.

7. The building structure of claim 1 wherein the silver and the dielectric layers alternate.

8. The building structure of claim 2 wherein the second protective layers are peelably adhered to one another.

9. The building structure of claim 2 wherein an exterior side of the first and second protective layers has an ultraviolet light absorbing hard coat.

10. The building structure of claim 1 wherein adhesive of the adhesive layer is an ultraviolet light absorbing adhesive.

11. The building structure of claim 1 wherein the first protective layer is sufficiently thick to reduce the rate of oxidation of the silver layer to a level such that the film has a sufficiently useful long life.

12. The building structure of claim 1 wherein the first and second protective layers are fabricated from biaxially-oriented polyethelene terephthalate.

13. The building structure of claim 1 further comprising a protective liner attached to the adhesive layer, the protective liner being cut into a pattern such that a first portion of the protective liner remains attached to the adhesive layer for forming the gap and a second portion of the protective liner is removed from the adhesive layer for exposing the adhesive to secure the film to the glass window.

14. A method for reducing an amount of solar radiation entering a building structure and for increasing insulation value of a window of the building structure, the method comprising the steps of:
providing a film for reflecting infrared radiation, the film comprising:
an infrared reflecting layer defining an interior side and an exterior side, the infrared reflecting layer having an embedded infrared reflecting core which comprises one or more layers of silver and one or more layers of dielectric for reflecting infrared radiation to an exterior of the building structure and for reflecting thermal radiation to an interior of the building structure and a first protective layer attached to the exterior side of the infrared reflecting core for mitigating oxidation of the silver layer;
attaching a peripheral edge portion of the film to an exterior side of the glass window; and
forming a gap between the film and the glass window for reducing a coefficient of thermal conductivity through the window.

15. The method of claim 14 wherein the attaching step comprising the step of adhering the interior side of the infrared reflecting layer to the exterior side of the glass window.

16. The method of claim 14 further comprising the step of providing a stack of sacrificial layers removeably attached to each other such that a top most sacrificial layer may be removed and discarded when the top most protective layer is damaged due to ultraviolet light exposure or oxidation; and mounting the stack of sacrificial layers to the first protective layer.

17. A building structure comprising:
a glass window defining an interior side and an exterior side;
a film attached to the exterior side of the glass window for reflecting infrared radiation away from the glass window to an exterior of the building structure and for reflecting thermal radiation back into an interior of the building structure, the film comprising:
infrared reflecting core which comprises one or more layers of silver and one or more layers of dielectric for reflecting infrared radiation, the infrared reflecting core defining opposed first and second sides;
first protective layers attached to the first and second sides of the infrared reflecting core, the first protective layer attached to the first side having a first thickness, the first protective layer attached to the second side having a second thickness, the first thickness being greater than the second thickness;
wherein the first protective layers provide structural support to the one or more silver layers, and the thicker first protective layer mitigates oxidation of the one or more silver layers caused by oxygen diffusion through the first protective layer attached to the first side of the infrared reflecting layer;
an adhesive layer disposed between the film and the glass window for adhering the film to the glass window, the adhesive layer disposed along a peripheral edge portion of the film for forming a gap between the glass window and the film interior to the peripheral edge portion of the film wherein the gap reduces the coefficient of thermal conductivity through the window.

18. The building structure of claim 17 further comprising a stack of sacrificial layers attached to the first protective layer attached to the first side of the infrared reflecting core and removeably attached to each other such that a top most sacrificial layer may be removed and discarded when the top most sacrificial layer is damaged due to ultraviolet light exposure or oxidation.

19. The building structure of claim 17 wherein the sacrificial layers are adhered to each other.

20. The building structure of claim 17 wherein the first thickness is sufficiently thick to reduce the rate of oxidation of the silver layer to a level such that the film has a sufficiently long useful life.

21. The building structure of claim 17 wherein the film has a lower coefficient of thermal conductivity compared to the glass window.

22. The building structure of claim 17 further comprising a protective liner attached to the adhesive layer, the protective liner being cut into a pattern such that a first portion of the protective liner remains attached to the adhesive layer for forming the gap and a second portion of the protective liner is removed from the adhesive layer for exposing the adhesive to secure the film to the glass window.

23. A film for reflecting radiation away from a glass window to an exterior of a building structure and for reflecting thermal radiation back into an interior of the building structure, the film comprising:
an infrared reflecting layer defining an interior side and an exterior side, the interior side of the infrared reflecting layer attached to the exterior side of the glass window, the infrared reflecting layer having:
an embedded infrared reflecting core which comprises one or more layers of silver and one or more layers of dielectric for reflecting infrared radiation; and
a first protective layer attached to the exterior side of the infrared reflecting core for mitigating oxidation of the silver layer;
an adhesive layer disposed on the interior side of the infrared reflecting layer for attaching the infrared reflecting layer to the exterior of the glass window, the adhesive layer disposed along a peripheral edge portion of the infrared reflecting layer for forming a gap between the glass window and the film interior wherein the gap reduces a coefficient of thermal conductivity through the window.

24. The film of claim 24 wherein the first protective layer is biaxially-oriented polyethelene terephthalate.
